(19) United States
(12) Patent Application Publication
(10) Pub. No.: US 2023/0113496 A1
(43) Pub. Date: Apr. 13, 2023

(54) CO-POLARIZED TRANSMISSION AND PORT SELECTION

(71) Applicant: NOKIA TECHNOLOGIES OY, Espoo (FI)

(72) Inventors: Rana AHMED SALEM, Munich (DE); Frederick VOOK, Schaumburg, IL (US); Filippo TOSATO, Bures sur Yvette (FR); Eugene VISOTSKY, Buffalo Grove, IL (US)

(21) Appl. No.: 17/498,738

(22) Filed: Oct. 11, 2021

(51) Int. Cl. H04B 7/10; H04L 5/00; H04B 7/0456; H04B 7/06

(52) U.S. Cl. CPC H04B 7/10; H04L 5/0023; H04B 7/0473; H04B 7/0626

(57) ABSTRACT

Systems, methods, apparatuses, and computer program products for co-polarized transmission and port selection associated therewith are provided. For example, a method can include feeding back compressed channel state information. The channel state information can include combining coefficients used to combine a number of space domain, frequency domain, or both space and frequency domain ports. At least one layer can be restricted to be transmitted on one polarization. The feedback for the at least one layer only involves the combining coefficients on the one polarization.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for providing co-polarized transmission and port selection associated therewith.

### BACKGROUND

Examples of mobile or wireless telecommunication systems may include the Universal Mobile Telecommunications System (UNITS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mNITC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus. The apparatus can include at least one processor and at least one memory comprising computer program code. The at least one memory and computer program code can be configured, with the at least one processor, to cause the apparatus at least to perform feeding back, by a user equipment, compressed channel state information. The user equipment can be configured with a port selection codebook. The channel state information can include combining coefficients used to combine a number of space domain, frequency domain, or both space and frequency domain ports. At least one layer can be restricted to be transmitted on one polarization. The feedback for the at least one layer only involves the combining coefficients on the one polarization.

An embodiment may be directed to an apparatus. The apparatus can include at least one processor and at least one memory comprising computer program code. The at least one memory and computer program code can be configured, with the at least one processor, to cause the apparatus at least to perform configuring a terminal to feed back compressed channel state information without co-phasing information or without combining coefficients. The at least one memory and computer program code can also be configured, with the at least one processor, to cause the apparatus at least to perform receiving fed back compressed channel state information without co-phasing information or without combining coefficients.

An embodiment may be directed to an apparatus. The apparatus can include at least one processor and at least one memory comprising computer program code. The at least one memory and computer program code can be configured, with the at least one processor, to cause the apparatus at least to perform receiving fed back compressed channel state information. The channel state information can include combining coefficients used to combine a number of space domain, frequency domain, or both space and frequency domain ports. At least one layer can be restricted to be transmitted on one polarization. The feedback for the at least one layer only involves the combining coefficients on the one polarization.

An embodiment may be directed to a method. The method can include feeding back, by a user equipment, compressed channel state information. The user equipment can be configured with a port selection codebook. The channel state information can include combining coefficients used to combine a number of space domain, frequency domain, or both space and frequency domain ports. At least one layer can be restricted to be transmitted on one polarization. The feedback for the at least one layer only involves the combining coefficients on the one polarization.

An embodiment may be directed to a method. The method can include configuring a terminal to feed back compressed channel state information without co-phasing information or without combining coefficients. The method can also include receiving fed back compressed channel state information without co-phasing information or without combining coefficients.

An embodiment may be directed to a method. The method can include receiving fed back compressed channel state information. The channel state information can include combining coefficients used to combine a number of space domain, frequency domain, or both space and frequency domain ports. At least one layer can be restricted to be transmitted on one polarization. The feedback for the at least one layer only involves the combining coefficients on the one polarization.

An embodiment may be directed to an apparatus. The apparatus can include means for feeding back, by a user equipment, compressed channel state information. The user equipment can be configured with a port selection codebook. The channel state information can include combining coefficients used to combine a number of space domain, frequency domain, or both space and frequency domain ports. At least one layer can be restricted to be transmitted on one polarization. The feedback for the at least one layer only involves the combining coefficients on the one polarization.

An embodiment may be directed to an apparatus. The apparatus can include means for configuring a terminal to feed back compressed channel state information without co-phasing information or without combining coefficients. The apparatus can also include means for receiving fed back compressed channel state information without co-phasing information or without combining coefficients.

An embodiment may be directed to an apparatus. The apparatus can include means for receiving fed back compressed channel state information. The channel state information can include combining coefficients used to combine a number of space domain, frequency domain, or both space and frequency domain ports. At least one layer can be restricted to be transmitted on one polarization. The feedback for the at least one layer only involves the combining coefficients on the one polarization.

### BRIEF DESCRIPTION OF THE DRAWINGS

For proper understanding of example embodiments, reference should be made to the accompanying drawings, wherein:

FIG. 1 illustrates a flow chart of partial reciprocity based port selection.

FIG. 2 illustrates performance of Rel-17 ePS and Rel-16 eType II and Type I at 3 kmph and 30 kmph.

FIG. 3 illustrates a baseline procedure for PMI calculation at the UE side assuming 2 layer feedback.

FIG. 4 illustrates procedures for precoding matrix indicator calculation in co-polarized feedback mode at the user equipment side, according to certain embodiments.

FIG. 5 illustrates alternative procedures precoding matrix indicator calculation in co-polarized feedback mode at the user equipment side, according to certain embodiments.

FIG. 6 illustrates a method for providing co-polarized transmission and port selection associated therewith, according to certain embodiments.

FIG. 7A illustrates an example block diagram of an apparatus, according to an embodiment; and

FIG. 7B illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing co-polarized transmission and port selection associated therewith, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Certain embodiments address high mobility support. Significant gains achieved by advanced codebooks, may disappear as physical speed of a user equipment increases, sometimes even at moderate speeds.

Various co-polarized feedback schemes can be used. For example, a codebook construction can include transmitting the combining coefficients for each layer on only one of the two polarizations. Thus, the final precoding weights assigned to antenna ports on one layer may be transmitted from only one of the two polarizations.

With cross-polarized arrays, whether in frequency range 1 (FR1) or frequency range 2 (FR2), the co-polarized elements may be highly correlated, whereas the correlation across polarizations may be low. As a result, a first beam is formed with the elements of one polarization and a second beam is formed with the elements of the other polarization, then each beam will tend to be more stable over time and frequency due to the high correlation of the channel responses on the elements being beamformed. Here, stability can refer to how the beam stays effective across time or frequency in spite of multipath fading. However, the combined scalar channel formed by one beam on one polarization may be uncorrelated with the combined scalar channel formed by the other beam on the other polarization. Therefore, layers formed over only co-polarized elements may be more stable over both time and frequency compared with layers formed over elements of both polarizations. As a result, the coefficients that form the layers may be less variable over frequency and therefore may benefit more from frequency-domain compression than layers formed over sets of cross-polarized elements.

Co-polarized feedback may have a positive impact on enhancing performance for high speed UEs and/or at UEs at high carrier frequencies. At high Doppler shifts, the combined channel over both polarizations becomes less and less ‘stable’ overtime.

In Rel. 15 type II codebook, the precoding matrix, per layer, can be written as follows:

W=W₁W₂ Equation (1)

The grid-of-beam matrix, W₁, can be of size 2N₁N₂×2L and can be built out of L orthogonal vectors/beams per polarization r from a set of oversampled O₁O₂N₁N₂ DFT beams, where N₁ and N₂ can represent the number of antenna ports in horizontal and vertical domains. O₁ and O₂ can represent the oversampling factors in both dimensions. This collection of vectors can be used to approximate the eigenvectors of the channel covariance matrix by means of suitable weighted linear combinations.

This operation can achieve a compression in the spatial domain (SD), hence the resulting 2L beams, which may also be referred to as SD components.

The final precoder at the gNB is a weighted linear combination of L orthogonal beams per polarization as follows

$${\tilde{w}}_{r , l} = {\sum }_{i = -}^{L - 1} {b}_{{k}_{1}^{( i )} {k}_{2}^{( i )}} \cdot {p}_{r , l , i}^{( WB )} {p}_{r , l , i}^{( SB )} \cdot {c}_{r , l , i} \qquad Equation ( 1.5 )$$

In Equation (1.5).

$${b}_{{k}_{1}^{( i )} {k}_{2}^{( i )}}$$

can represent the long term 2D DFT beam. Likewise, in Equation (1.5), p_{r,l,i}^{(WB)} can represent the beam power scaling factor for wideband and p_{r,l,i}^{(SB)} can represent the beam power scaling factor for subband. Finally, c_{r,l,i} can represent the beam combining coefficient.

Linear combination subband matrix W₂ can be of size 2L×N₃, where N₃ can represent the number of frequency subbands, and can be used for the weighted linear combination of the columns of W₁ yielding the aforementioned approximation of the 1 strongest eigenvectors of the channel covariance matrix.

The frequency correlation inside W₂ can be exploited to provide enhancement. A frequency domain compression scheme can be applied on subband matrix W₂. The precoder for each layer and across frequency-domain units W can be derived as follows

W=W₁\tilde{W}₂W_{f}^{H} Equation (2)

In Equation (2), \tilde{W}₂ can be a 2L×M matrix of linear combining coefficients, W_{f} can be an N₃×M FD compression matrix (analogous to W₁ in frequency domain), and M can be the number of frequency domain (FD) components.

In Rel. 16 type II channel state information (CSI), the UE can feed back the following to the gNB: grid-of-beam matrix W₁, FD basis subset W_{f}, and linear combination coefficients (LCC) \tilde{W}₂. At the UE side, W₂ can be computed as follows:

\tilde{W}₂=W₂W_{f} Equation (3)

In frequency division duplex (FDD) 5G systems, the gNB can use downlink reference signal (CSI-RS, SSB . . . ) transmission and Type I or Type II codebook feedback from the UE in order to obtain CSI at the gNB side needed for DL precoding, scheduling, and the like.

Advanced CSI codebooks may accommodate both single and multi-user MIMO operations. Release 15 (Rel-15) Type I and Type II codebooks may provide benefits, and the latter may provide considerable precoding matrix indicator (PMI) accuracy. CSI enhancements in Rel-16 may alleviate the strain on uplink resources by reducing Type II overhead. This may be achieved through frequency domain compression using discrete Fourier Transform (DFT) basis subsets. Further improvements may be achievable by exploiting partial uplink and downlink channel reciprocity.

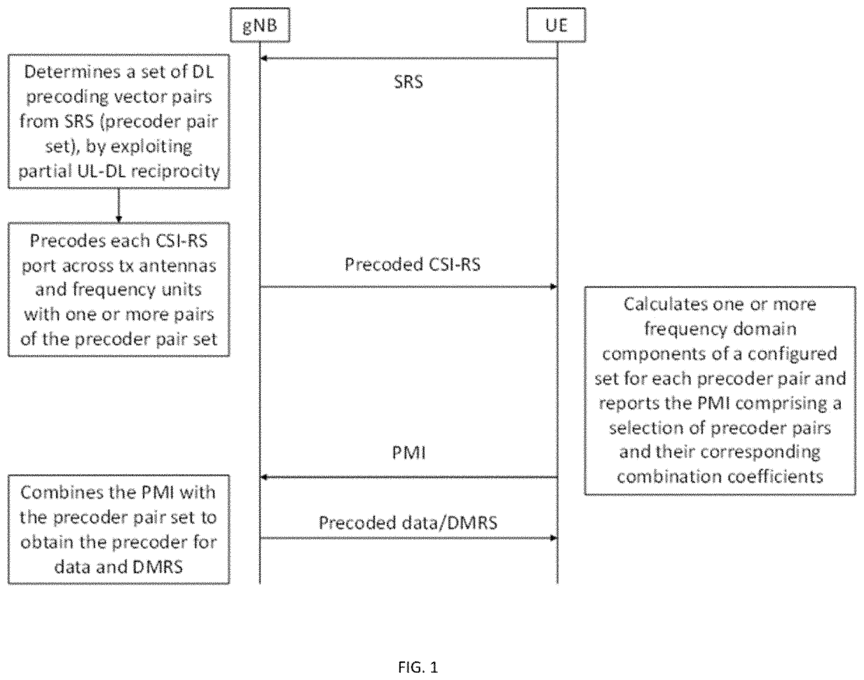

FIG. 1 illustrates a flow chart of partial reciprocity based port selection. As shown in FIG. 1, a gNB can receive a sounding reference signal from a UE. The gNB can accordingly determine a set of DL precoding vector pairs from the SRS, as a precoder pair set, by exploiting partial UL-DL reciprocity. Then, the gNB can precode each CSI reference signal (CSI-RS) port across transmission (Tx) antennas and frequency units, with one or more pair(s) of the precoder pair set. The precoded CSI-RS can be transmitted to and received by the UE. The UE can then calculate one or more frequency domain components of a configured set for each precoder pair and can report a pre-coding matrix indicator (PMI) that includes selection of precoder pairs and their corresponding combination coefficients. The gNB can then combine the PMI with the precoder pair set to obtain the precoder for data and demodulation reference signal (DMRS). The precoded data and DMRS can then be sent to the UE.

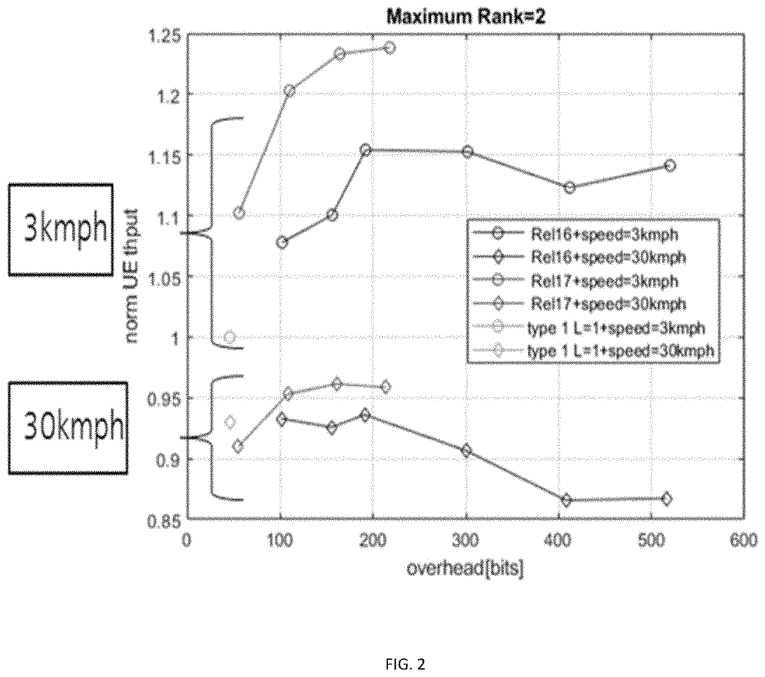

FIG. 2 illustrates performance of Rel-17 ePS and Rel-16 eType II and Type I at 3 kmph and 30 kmph. As shown in FIG. 2, at high speeds the performance benefits associated with Rel-17 ePS may decline. At low speeds, for example at 3 kilometers per hour, the Rel-17 may provide a significant improvement over Rel-16 approaches. Nevertheless, at even the modest speed of 30 kilometers per hour, the benefits may significant decline. Thus, for vehicles in motion at 30 kilometers per hour, Rel-17 may potentially underperform.

In further CSI enhancements, information related to angle(s) and delay(s) may be estimated at the gNB based on sounding reference signal (SRS) by utilizing DL/UL reciprocity of angle and delay, and the remaining DL CSI may be reported by the UE. Thus, type II port selection enhancements may take into consideration uplink and downlink channel partial reciprocity in terms of both delay(s) and angle(s).

The incorporation of partial reciprocity operations in 5G NR CSI framework may be based on type II port selection codebook enhancements. Type II port selection codebook can be based on spatially beamformed CSI-RS.

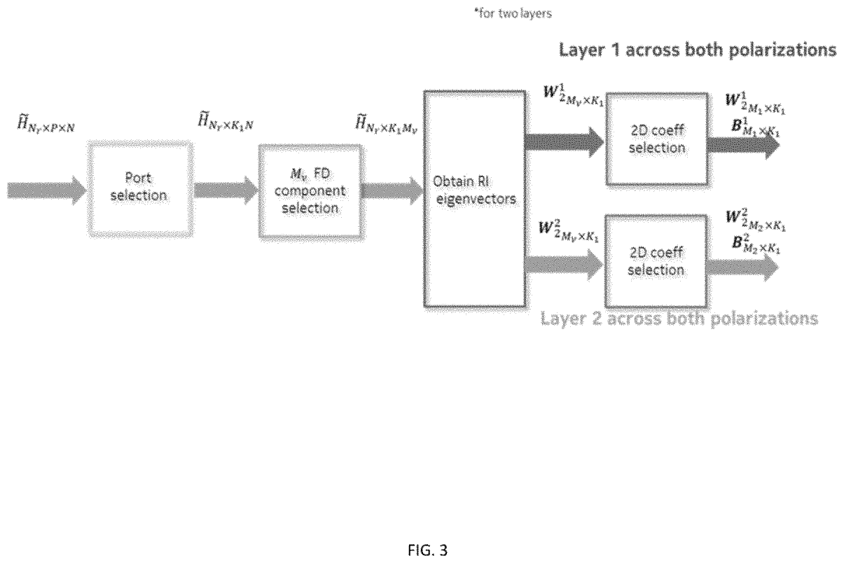

Assuming existing knowledge of the delay information (W_{f}) as well as spatial information (W₁) at gNB side from UL SRS, FIG. 3 illustrates a possible approach.

FIG. 3 illustrates a baseline procedure for PMI calculation at the UE side assuming 2 layer feedback. According to the approach illustrated in FIG. 3, which may be involve a further enhanced port selection codebook, the matrix of combining coefficients W₂ can be derived for each layer across the 2 polarizations.

In the approach of FIG. 3, at the gNB side, the CSI-RS ports can be pre-coded across Tx antennas and frequency units with spatial-delay precoding vectors Wⱼₒᵢₙₜ=W*_{FD} ⊗W_{SD}. Each precoding vector can correspond to a precoder pair including one significant delay tap and one dominant beam direction in the spatial domain. The precoding vector can be used to create 1 CSI-RS port.

At the UE side, for each port (p=1 . . . P), the inner product of the received signal on the different frequency subbands with the known pilot sequence (CSI-RS) may yield nothing but the compressed channel coefficients \tilde{H}_{P×N}_{ᵣ}.

After a step of singular value computation on \tilde{H}_{P×N}_{ᵣ}, the UE can obtain linear combining coefficients across ports W₂_{_{P×v}} which can then be fed back to the gNB. Hence the UE may be spared from the effort of computing the W_{f}, and also gNB may have the freedom to apply any kind of sophisticated spatial or frequency domain precoders, not having to be restricted by a codebook structure.

At the gNB side, given knowledge of CSI-RS precoder and given the UE PMI feedback, the gNB may be capable of building the whole CSI used for design of the DL precoder.

There may be still further improvements to this approach. For example, a co-polarized feedback scheme can be applied to NR type II and NR eType II feedback schemes. The codebook construction can include transmitting the combining coefficients for each layer on only one of the two polarizations. For example, the final precoding weights assigned to antenna ports on one layer can be transmitted from only one of the two polarizations.

A co-polarized feedback scheme can be applied on a matrix of combining coefficients W₂ used to combine a number of SD components (beams) W₁ and potentially a number of FD components W_{f} which can be computed by the UE.

Certain embodiments provide a scheme that may allow the UE to select a favorite polarization-to-layer mapping. The gNB can also learn of this choice with no extra overhead requirement.

Certain embodiments involve applying a co-polarized feedback transmission to a Rel-17 ePS codebook, where the matrix of combining coefficients can be used to combine CSI-RS ports and not SD/FD components computed by the UE side, as in type II and eType II case. Each layer can be restricted to be transmitted at gNB over co-polarized antennas only.

Antenna ports corresponding to CSI-RS may differ from the antenna ports corresponding to DM-RS. For example, antenna ports corresponding to CSI-RS may correspond to actual transmit antenna ports without downlink data precoding. On the other hand, antenna ports corresponding to DM-RS can include downlink precoding applied at the transmitter side (same precoding that is applied for data symbols). Note that in some cases CSI-RS ports can spatially and/or frequency precoded in a manner transparent to the UE. In certain cases, the antenna ports corresponding to CSI-RS may be designated as antenna port 15 up to antenna port 22.

Furthermore, in certain embodiments the UE may have some freedom on the polarization-to-layer mapping. The choice of the polarization to layer mapping can be communicated to the gNB implicitly by knowledge of the strongest coefficient indicator (SCI). Thus, the UE may not need to explicitly inform the gNB of the polarization-to-layer mapping.

Furthermore, certain embodiments of a scheme can provide a generic feedback scheme from the UE where the short term feedback is fed back without the co-phasing information. For example, transmission on one polarization only may be assumed. The short term feedback information can be a set of combining coefficients which can be used to combine spatial beams, ports, or the like. The short term feedback information can also be beam co-phasing information, as in the case of type 1 feedback and LTE codebooks.

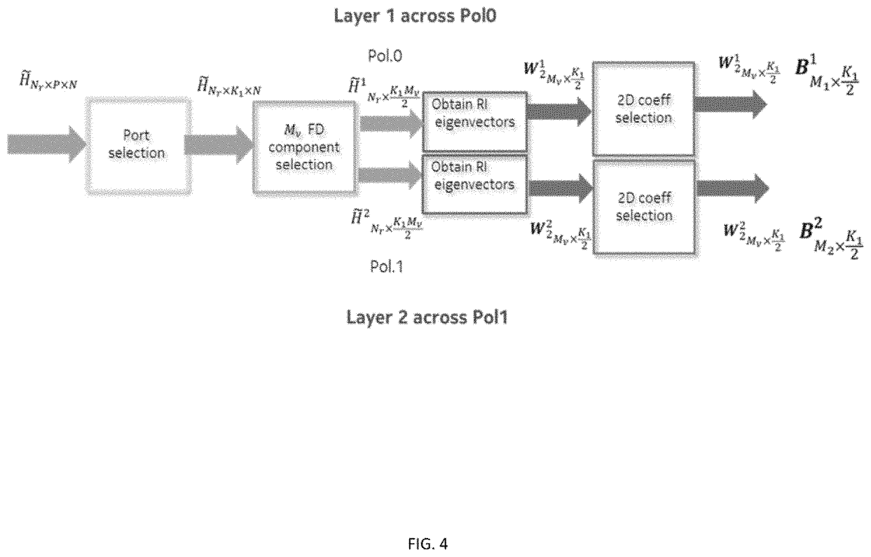

FIG. 4 illustrates procedures for precoding matrix indicator calculation in co-polarized feedback mode at the user equipment side, according to certain embodiments. The approach of FIG. 4 may be applicable to Rel-17 approaches and may assume 2 layer feedback.

In FIG. 4, the combining coefficients for layer 1 can be obtained from the strongest eigenvector of the first channel polarization. By contrast, the combining coefficients for layer 2 can be obtained from the strongest eigenvector of the second channel polarization.

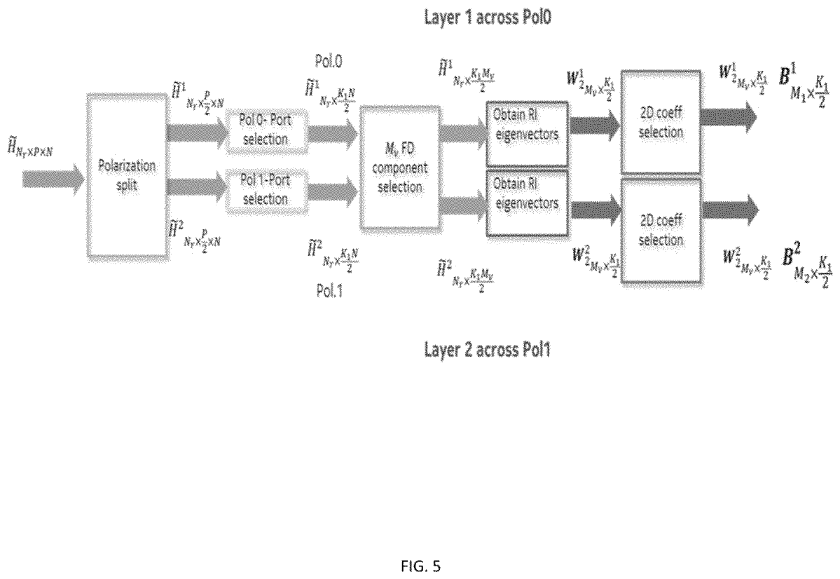

FIG. 5 illustrates alternative procedures precoding matrix indicator calculation in co-polarized feedback mode at the user equipment side, according to certain embodiments. In FIG. 5, the port selection can be done differently per polarization. Thus, there may be polarization-specific port selection. Otherwise, the approach of FIG. 5 may be similar to that of FIG. 4.

In order to deal with a case when the channel on one polarization is at one time instance stronger than on the other polarization, or for other reasons, the UE may have choice of the polarization-to-layer mapping. For example, with rank=3 UE may choose to obtain 2 layers from polarization 0 and one layer from polarization 1. In another example, UE may choose to obtain 2 layers from one polarization (0 or 1).

Without excessive signaling, the gNB can learn about the UE choice from the value given of the strongest coefficient indicator (SCI). The SCI can point to the position of the strongest combination coefficient and can be used for the quantization step in Rel-17 further enhanced port selection codebook as well as in Rel-16 eType II codebook. From the SCI value, the gNB can infer at which polarization the strongest component is, hence SCI indicated per layer tells the gNB which layer was used on which polarization. In other words, W₂ can be restricted to the polarization of the coefficient indicated by the SCI.

For example, assuming the UE is configured for Rel-16 eType II feedback, the strongest coefficient of layer l may be identified by the SCI i_{1,8,l}, from which the gNB may obtain the index i*ₗ ∈{0, 1, . . . , 2L−1} of the selected CSI-RS port (or beam) corresponding to the strongest coefficient. Therefore, the gNB can derive which of the two polarizations is associated to layer l, pₗ ∈{0,1} by applying the formula pₗ=i*ₗ.

When a UE is configured with Rel-17 fePS codebook, the strongest coefficient of layer 1 may be indicated by reporting the position [i*ₗ], where i*ₗ E {0,1, . . . , K₁−1} can be the index of the selected CSI-RS port corresponding to the strongest coefficients, and K₁ is the number of ports selected by the UE. Therefore, similarly to Rel-16, the gNB can derive which of the two polarisations is associated to layer l, pₗ ∈ {0,1} by applying the formula pₗ=└2i*ₗ/K₁┘.

When cross-polarization and co-polarization transmission occur, this can be considered a hybrid variant. For example with rank=3, layer 1 can choose to span both polarizations while layers 2 and 3 can each span one polarization only. In that case, the co-phasing information of layer 1 can be sent and there may be no layer-to-polarization mapping of layer 1. Thus, the gNB may not need to use the SCI of layer 1 for that purpose. However, for layers 2 and 3 the SCI can be used as described above to determine the layer-to-polarization mapping.

Unlike Type II, eType II and FePS Type II (in Rel-17) in which the codebook is built on beam combining, NR type I codebook can be built on beam selection. When UE is configured to feedback a NR type I codebook, the UE can feed back (for rank 1), a grid of beam matrix Nₜ×2L matrix W₁ (wideband) and co-phasing information (per sub-band) W₂, size 2L×1.

In case L=1, W₂ can be written as where

$$[ \begin{matrix}1 \\ {e}^{j ϕ}\end{matrix} ]$$

where e^{jϕ} can be a co-phasing factor between the two orthogonal polarizations, that for rank-1 precoding is selected from a quadrature phase-shift keyed (QPSK) alphabet

$$ϕ ∈ \{ 0 , \frac{π}{2} , π , \frac{3 π}{4} \} .$$

For L=4 can be written as

$$[ \begin{matrix}{e}_{1} \\ {e}^{j ϕ} {e}_{1}\end{matrix} ]$$

where e₁ can be a unit vector that selects one beam out of 4 beams inside W₁.

At a high speed when a co-polarized transmission of each layer, the UE may not feed back the co-phasing information ϕ.

When each layer is confined to be transmitted out of only one polarization, another aspect to consider is the impact on the per-layer transmit power that results when the number of layers is odd. Ordinarily in current CSI/PMI schemes, all layers are transmitted across both polarization, and a simple 1/(total number of layers) type of scaling of the TX power on each layer may be assumed. Given the nature of the spatial channel, the layers will have differing strengths due to the eigenvalues/modes of the channel.

In certain embodiments of a co-polarization approach, the total power on each polarization can be assumed to be the same. With an even number of layers, all layers may have the same Tx power, but that may not be the case for an odd number of layers. For example, if the rank is 3, two layers may be split on one polarization, so the total TX power of those two layers may equal the TX power of the one layer that is all by itself on the other polarization. Thus, with an odd number of layers, some layers may have less Tx power than others, which may compound the issue of differing layer strengths due to the channel eigenmodes. In certain embodiments, the UE can adjust the TX power of the layers and feed back the scaling factors. Another alternative is to have layer 1 be transmitted out of both polarizations, while the remaining layers are each transmitted out of only one polarization.

Certain embodiments may provide novel configuration, UE behavior, new dynamic downlink signaling, and new UE reporting, either individually or in combination with one another.

In certain embodiments, an SCI value can be used to indicate polarization to layer mapping. In certain embodiments, the CSI-RS ports for one layer may only be transmitted over one polarization. There may also be a definition of the coefficient selection step, for example bit-map, and a corresponding processing chain at the UE and the gNB.

Certain embodiments may provide or rely on a variation of NR Type I codebook where the co-phasing information is not fed back to the gNB. Furthermore, certain embodiments may involve the UE feeding back scaling factors to the gNB to avoid unequal transmit power on each polarization.

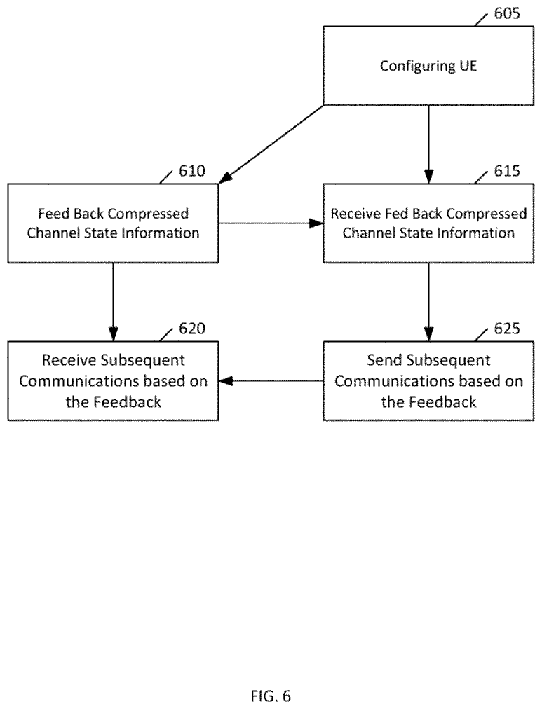

FIG. 6 illustrates a method for providing co-polarized transmission and port selection associated therewith, according to certain embodiments. As shown in FIG. 6, a method can include, at 610, feeding back compressed channel state information from a user equipment (for example, a terminal) to a network element (for example, a gNB). The channel state information can include combining coefficients used to combine a number of space domain, frequency domain, or both space and frequency domain ports. At least one layer can be restricted to be transmitted on one polarization. The feedback for the at least one layer may only involve the combining coefficients on the one polarization,

A choice of polarization to layer mapping can be communicated implicitly by a strongest coefficient indicator. Thus, for example, the strongest coefficient indicator can be included with the fed back compressed channel state information. The choice may be made by the UE. The user equipment can determine the polarization to layer mapping. For example, the UE can choose any polarization to layer mapping. The fed back compressed channel state information can be received at the network at 615. The network element can then send subsequent communications based on the feedback at 625, which can be received by the user equipment at 620. Examples of such subsequent communications are illustrated in FIG. 1, in which the gNB, an example of a network element, sends the UE precoded data and/or DMRS.

A bitmap can be used for coefficient selection for at least one layer. This bitmap may be applicable to one polarization only.

The user equipment can perform port selection. Port selection can be performed separately for each polarization.

The combining coefficients can be obtained from a strongest eigenvector of a given channel polarization, as explained above.

The feeding back the compressed channel state information can include feeding back scaling factors. The scaling factors can be configured to avoid unequal transmit power among polarizations.

The method of FIG. 6 can also include, at 605, configuring a terminal to feed back compressed channel state information without co-phasing information or without combining coefficients. For example, the compressed channel state information without co-phasing information, without combining coefficients, or with neither co-phasing information nor combining coefficients. This configuring can be performed by the network element. Thus, the receiving at 615 can include receiving fed back compressed channel state information without co-phasing information or without combining coefficients.

It is noted that FIG. 6 is provided as one example embodiment of a method or process. However, certain embodiments are not limited to this example, and further examples are possible as discussed elsewhere herein.

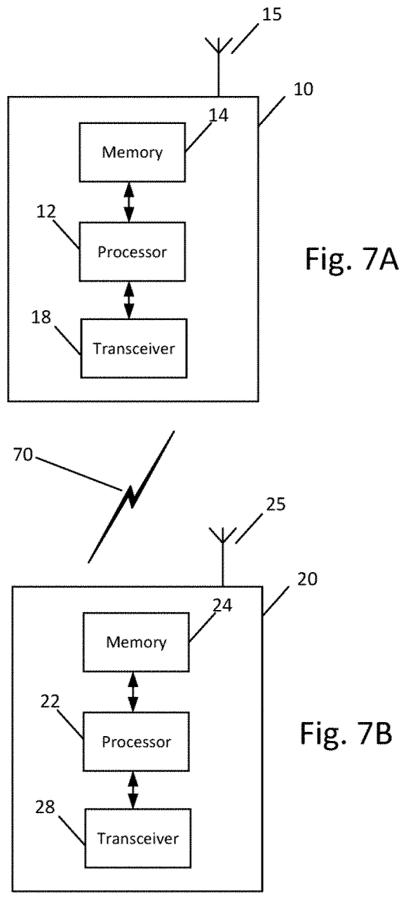

FIG. 7A illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 7A.

As illustrated in the example of FIG. 7A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 7A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-6, or any other method described herein. In some embodiments, as discussed herein, apparatus 10 may be configured to perform a procedure relating to providing co-polarized transmission and port selection associated therewith, for example.

FIG. 7B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 7B.

As illustrated in the example of FIG. 7B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 7B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-6, or any other method described herein. For example, in an embodiment, apparatus 20 may be controlled to perform a process relating to providing co-polarized transmission and port selection associated therewith, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and/or advantages. For example, the mechanism of certain embodiments may permit effective operation even when user equipment are traveling at speeds significantly above 3 kmph. Moreover, certain embodiments may permit communication of mapping between polarization and layer without additional signaling overhead.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

Partial Glossary:
3GPP 3rd Generation Partnership Project
AoA Angle of arrival
AoD Angle of departure
CSI Channel state information
CSI-RS Channel state information reference signal
DFT Discrete Fourier Transform
FD Frequency domain
FDD Frequency-division Duplex
gNB G Node B (BS name in NR)
LC Linear combination
LTE Long-term evolution
MIMO Multiple-Input Multiple-Output
NR New radio
PRB Physical resource block
PS Port selection
SCI Strongest Coefficient Indicator
SD Spatial domain
SRS Sounding reference signal

1. A method comprising:
feeding back, by a user equipment compressed channel state information, wherein the user equipment is configured with a port selection codebook and the compressed channel state information feedback comprises combining coefficients used to combine a number of space domain, frequency domain, or both space and frequency domain ports and wherein at least one layer is restricted to be transmitted on one polarization and the compressed channel state information feedback for the at least one layer only involves the combining coefficients on the one polarization.

2. The method of claim 1, further comprising:
determining, by the user equipment, polarization to layer mapping.

3. The method of claim 2 wherein the polarization to layer mapping is communicated implicitly by a strongest coefficient indicator.

4. The method of claim 1, further comprising:
performing port selection for a plurality of polarizations, which includes the one polarization, wherein port selection is performed separately for each polarization.

5. The method of claim 1, wherein a bitmap is used for coefficient selection in the combining coefficients for the at least one layer, wherein the bitmap is applicable to the one polarization only.

6. The method of claim 1, wherein the combining coefficients of the compressed channel state information feedback on the at least one layer are obtained from a strongest eigenvector of a given channel polarization.

7. The method of claim 1, wherein the feeding back the compressed channel state information comprises feeding back scaling factors, wherein the scaling factors are configured to avoid unequal transmit power among at least another polarization and the one polarization.

8-13. (canceled)

14. An apparatus, comprising:
at least one processor; and
at least one memory including computer program instructions, wherein the at least one memory and the computer program instructions are configured to, with the at least one processor, cause the apparatus to at least perform:
feeding back compressed channel state information, wherein the apparatus is configured with a port selection codebook and the compressed channel state information feedback comprises combining coefficients used to combine a number of space domain, frequency domain, or both space and frequency domain ports and wherein at least one layer is restricted to be transmitted on one polarization and the compressed channel state information feedback for the at least one layer only involves the combining coefficients on the one polarization.

15. The apparatus of claim 14, wherein the at least one memory and the computer program instructions are configured to, with the at least one processor, cause the apparatus to at least perform:
determining polarization to layer mapping.

16. The apparatus of claim 15, wherein the polarization to layer mapping is communicated implicitly by a strongest coefficient indicator.

17. The apparatus of claim 14, wherein the at least one memory and the computer program instructions are configured to, with the at least one processor, cause the apparatus to at least perform:
performing port selection for a plurality of polarizations, which includes the one polarization, wherein port selection is performed separately for each polarization.

18. The apparatus of claim 14, wherein a bitmap is used for coefficient selection in the combining coefficients for the at least one layer, wherein the bitmap is applicable to the one polarization only.

19. The apparatus of claim 14, wherein the combining coefficients of the compressed channel state information feedback on the at least one layer are obtained from a strongest eigenvector of a given channel polarization.

20. The apparatus of claim 14, wherein the feeding back the compressed channel state information comprises feeding back scaling factors, wherein the scaling factors are configured to avoid unequal transmit power among at least another polarization and the one polarization.

21. (canceled)

22. An apparatus, comprising:
at least one processor; and
at least one memory including computer program instructions, wherein the at least one memory and the computer program instructions are configured to, with the at least one processor, cause the apparatus to at least perform:
receiving fed back compressed channel state information, wherein the fed back compressed channel state information comprises combining coefficients used to combine a number of space domain, frequency domain, or both space and frequency domain ports and wherein at least one layer is restricted to be transmitted on one polarization and the fed back compressed channel state information feedback for the at least one layer only involves the combining coefficients on the one polarization.

23. The apparatus of claim 22, wherein a choice of mapping the one polarization to the at least one layer is communicated implicitly by a strongest coefficient indicator.

24. The apparatus of claim 22, wherein a bitmap is used for coefficient selection in the combining coefficients for the at least one layer, wherein the bitmap is applicable to the one polarization only.

25. The apparatus of claim 22, wherein the combining coefficients of the fed back compressed channel state information are obtained from a strongest eigenvector of a given channel polarization.

26. The apparatus of claim 22, wherein the fed back compressed channel state information comprises scaling factors, wherein the scaling factors are configured to avoid unequal transmit power among at least another polarization and the one polarization.

27-39. (canceled)
